(19) United States
(12) Patent Application Publication
(10) Pub. No.: US 2003/0147453 A1
(43) Pub. Date: Aug. 7, 2003

(54) Adaptive frequency hopping communication scheme

(75) Inventor: Anuj Batra, Dallas, TX (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/263,520

(22) Filed: Oct. 3, 2002

Related U.S. Application Data
(60) Provisional application No. 60/355,010, filed on Feb. 6, 2002.

(51) Int. Cl. H04B 1/713

(52) U.S. Cl. 375/132

(57) ABSTRACT

An adaptive hopping scheme for a wireless communication device (e.g., a Bluetooth-enabled device) takes into account current channel conditions when creating the sequence of hop frequencies. Preferably, the adaptive hopping sequence groups good channels together and bad channels together to minimize instances in which a good channel follows a bad channel and vice versa.

### CROSS-REFERENCE TO RELATED APPLICATIONS

This application is a non-provisional application claiming priority to provisional application Serial No. 60/355,010 filed on Feb. 6, 2002, entitled “Adaptive Frequency Hopping Via Unified Partition Sequences,” the teachings of which are incorporated by reference herein.

### STATEMENT REGARDING FEDERALLY SPONSORED RESEARCH OR DEVELOPMENT

Not applicable.

### BACKGROUND OF THE INVENTION

1. Field of the Invention

The present invention generally relates to wireless communications. More particularly, the invention relates to a frequency “hopping” scheme in which wireless communications are conducted using discrete carrier frequencies that vary numerous times each second. Still more particularly, the invention relates to an adaptive frequency hopping scheme which structures the hop frequencies based on the current conditions (e.g., interference, noise) present on the various frequencies in such a way that mitigates the detrimental effects of such conditions.

2. Background Information

Initially, computers were most typically used in a standalone manner. It is now commonplace for computers and other types of electronic devices to communicate with each other. The ability for computers to communicate with one another has lead to the creation of small networks comprising two or three computers to vast networks comprising hundreds or even thousands of computers. Networks thus can be set up to provide a wide assortment of capabilities. For example, networked computers can be established so as to permit each computer to share a centralized mass storage device or printer. Further, networks enable electronic mail and numerous other types of services. Networks can be established in a wired configuration in which each entity on the network has a direct physical electrical connection to the network. More recently, wireless technology has increased in popularity to provide wireless data communications to the entities on the network.

A variety of wireless communication protocols exist. Examples include the Bluetooth and IEEE 802.11 protocols. Bluetooth is designed to permit relatively short range communications (less than about 30 feet) between consumer electronic devices, such as computers, printers, and the like. One characteristic of the Bluetooth standard is that it requires the transmitting and receiving devices to “hop” from one frequency to another across its frequency spectrum. Bluetooth devices are permitted by the Federal Communications Commission (“FCC”) to operate in the Industry, Scientific, Medial (“ISM”) frequency band which starts at 2400 MHz. According to the Bluetooth standard, Bluetooth-enabled devices are permitted to communicate at one of the Bluetooth specified frequencies between 2400 MHz and 2483.5 MHz for a short while and then switch (“hop”) to another frequency in that band for further communications. Each carrier frequency at which a communication is permitted to occur is called a “channel.” The channels onto which Bluetooth devices are permitted to hop include 79 channels spaced 1 MHz apart in the 2400-2483.5 MHz frequency band. The current FCC requirement requires Bluetooth devices in the U.S. to hop over at least 75 channels every 30 seconds. FIG. 1 illustrates this concept with a sequence of seven hops beginning at hop number 1 through hop number 7. Hop frequency increases to the right in this plot. As shown, hopping begins at 1, then proceeds to 2, then 3, and so on, hopping back and forth in a pseudo-random fashion through the available channels.

At least one reason for frequency-hopping is to spread the power density over a wider frequency spectrum (i.e., not to concentrate too much power at any one frequency). Frequency hopping also serves to ameliorate the effects of noise or interference. If interference is present on one channel at a large enough magnitude to prevent a communication from occurring, the Bluetooth devices will quickly hop to another channel that may not have any, or much, interference. The former channel is referred to as a “bad” channel, and the latter a “good” channel. Once subsequently tuned to a good channel, the devices can retry the previously failed communication. Thus, referring again to FIG. 1, if the channels at hop numbers 4 and 6 are currently inundated with an excessive amount of noise 15, then communications will be ineffective on those channels and the communications will have to be retried at the next relatively noise-free channel (i.e., at hops 5 and 7, respectively).

Traditional frequency hopping schemes had the devices pseudo-randomly hopping from one channel to another without regard to whether a channel was good or bad. Frequency hopping is a generally satisfactory scheme for the reasons stated above, but, statistically, frequency hopping Bluetooth devices will encounter bad channels which impair communication performance. Recently, various types of “adaptive frequency hopping” schemes have been proposed which attempt to hop only over good channels, and avoid the bad channels. If there are enough available good channels in the frequency band to comply with the applicable regulations, then such schemes can work satisfactorily. However, a sufficient number of good channels cannot always be guaranteed, particularly since the ISM band is generally available to many types of devices including IEEE 802.11b enabled devices, microwave ovens, and other devices and equipment.

The problem then becomes what to do if there are not enough good channels to comply with the applicable regulations (e.g., FCC) regarding the minimum number of hopping channels in a given period of time. A solution to this problem is needed.

### BRIEF SUMMARY OF THE PREFERRED EMBODIMENTS OF THE INVENTION

The preferred embodiments of the present invention solve the problems noted above by an adaptive hopping scheme that takes into account current channel conditions when creating the sequence of hop frequencies. Preferably, the adaptive hopping sequence groups good channels together and bad channels together to minimize instances in which a good channel follows a bad channel and vice versa. In this way, the potential for wasting a good channel that immediately follows or precedes a bad channel is reduced and throughput is increased.

In accordance with a preferred embodiment of the invention, a wireless device includes a radio coupled to an antenna an adaptive frequency hopping logic unit. The adaptive frequency hopping logic unit generates the preferred sequence of hop frequencies to be used by the radio to conduct communications with other wireless devices. The adaptive frequency hopping logic unit preferably includes a hop kernel and a partition sequence generator coupled to a frequency re-mapper. The hop kernel generates a conventional sequence of hop frequencies and the re-mapper uses information provided by the partition sequence generator to re-map, if necessary, the sequence of hop frequencies provided by the hop kernel. An assessment of the quality of each channel is made to identify the good channels and the bad channels. A good channel is one on which effective communications can occur, while a bad channel is a channel on which effective communications cannot occur. If there are enough available good channels to satisfy the applicable regulations (e.g., regulations promulgated by the FCC), only good channels are included in the hop sequence, thereby improving communication throughput.

If however, there are not enough good channels given the applicable regulations, then one or more bad channels are added to the sequence to make the deficiency. The preferred embodiment of the invention introduces the bad channels in a way, however, that ameliorates the detrimental effects bad channels cause in a hopping sequence. To that end, the re-mapped frequency sequence created by the adaptive frequency hopping logic unit preferably includes a first plurality of windows (groups) of good channels and a second plurality of windows of bad channels. The bad channels windows preferably are disposed between the good channel windows in an alternating pattern. The lengths of the good channel windows (e.g., measured in units of time) in the first plurality preferably are equal as are the lengths of the bad channel windows in the second plurality. The lengths of the good channel windows may differ from the lengths of the bad channel windows, and preferably are longer than the lengths of the bad channel windows. If extra windows are further needed, then an extra window containing good channels and an extra window containing bad channels can be added to the aforementioned first and second pluralities of windows to complete a “superframe.”

The lengths of the various windows and other parameters associated with the superframe are computed in such a way as to create an optimal frequency hopping sequence that attempts to reduce the inefficiencies caused by bad channels. These and other aspects of the preferred embodiments of the present invention will become apparent upon analyzing the drawings, detailed description and claims, which follow.

### BRIEF DESCRIPTION OF THE DRAWINGS

For a detailed description of the preferred embodiments of the invention, reference will now be made to the accompanying drawings in which:

FIG. 1 shows a frequency spectrum illustrating frequency “hopping;”

FIG. 2 shows a wireless network implementing an adaptive hopping scheme in accordance with a preferred embodiment of the invention;

FIGS. 3a and 3b illustrate the detrimental effects of a good channel immediately following a bad channel, and vice versa;

FIG. 4 shows a preferred embodiment of an adaptive frequency hopping logic used to implement the preferred hopping sequence;

FIG. 5 shows the structure of the preferred hopping sequence of the preferred embodiment;

FIGS. 6a and 6b illustrate two conventional types of wireless connections; and

FIG. 7 shows a preferred embodiment of a frequency re-mapper.

### NOTATION AND NOMENCLATURE

Certain terms are used throughout the following description and claims to refer to particular system components. As one skilled in the art will appreciate, wireless device manufacturers may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical or wireless connection. Thus, if a first device couples to a second device, that connection may be through a direct electrical or wireless connection, or through an indirect electrical or wireless connection via other devices and connections. To the extent that any term is not specially defined in this specification, the intent is that the term is to be given its plain and ordinary meaning.

### DETAILED DESCRIPTION OF THE PREFERRED EMBODIMENTS

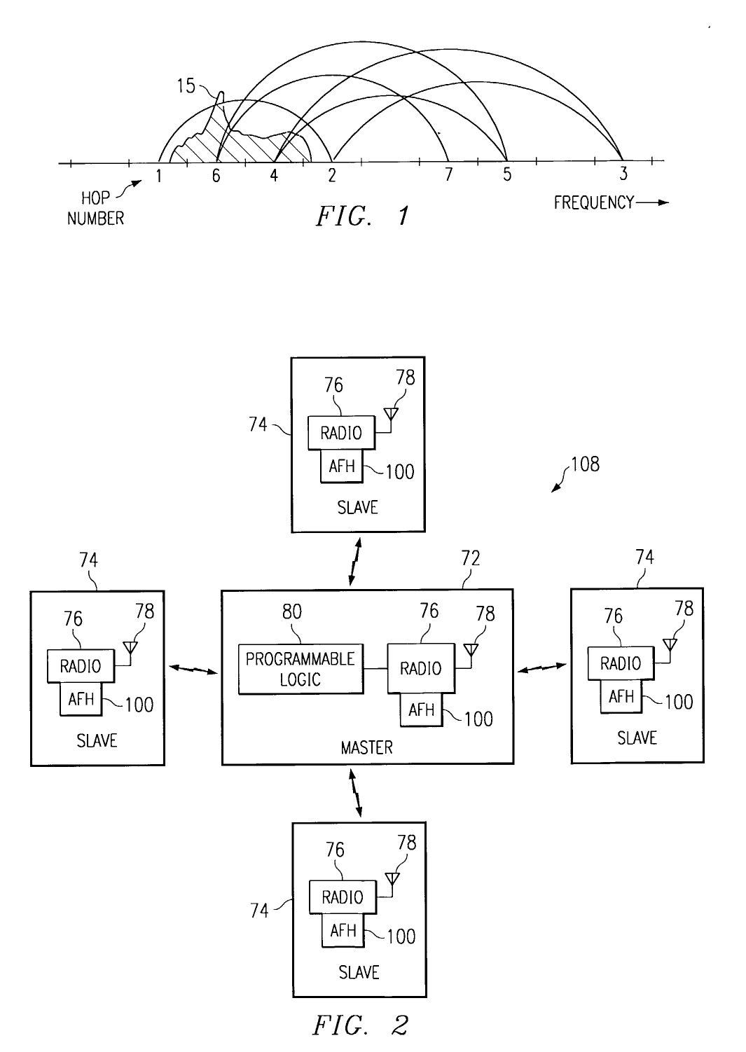

Bluetooth communications occur between a “master” and a “slave.” FIG. 2 shows an exemplary wireless Bluetooth configuration 108 in which a master 72 is able to communicate directly with one or more slave devices 74. The master is generally the device whose clock and hopping sequence are used to synchronize all other devices to which it communicates. The master also numbers the communication channels. As shown, the master 72 and each slave 74 include a radio circuit 76 and an associated antenna 78. An adaptive frequency hopping (“AFH”) logic 100 is also included in each device and will be described in detail below. Programmable logic 80 in the master will also be addressed below.

The Bluetooth standard provides for a master to transmit a data packet to a slave and the slave to answer or respond with an acknowledgment packet to let the master know the slave correctly received the initial transmission. The acknowledgment packet may also indicate that the slave is transmitting to the master. Thus, in the context of a hopping sequence, the master 72 may transmit an initial packet using the current hopping frequency. After the frequency hops to its next value, the slave 74 responds with the acknowledgment packet using the new frequency. If the master does not receive the acknowledgment packet as expected, it resends its initial packet. This scheme essentially requires two time slots for a transaction-one time slot for the master to send the initial packet and another time slot for the slave to send back its answer.

As explained previously, each channel may be characterized as “good” or “bad.”FIGS. 3a and 3b illustrate the effect of a bad channel in the master-to-slave and slave-to-master transaction described above. FIGS. 3a and 3b include two time slots 20 and 22 in which two different channels, according to a hopping scheme, are used to transmit information between a master (“M”) and a slave (“S”). In FIG. 3a, the channel in time slot 20 is bad as indicated by the “X”. In FIG. 3b, the other channel in time slot 22 is bad. In FIG. 3a, the packet 24 sent from the master to the slave is not correctly received by the slave because of the bad channel used in time slot 20. Consequently, in time slot 22 in which the master is expecting an answer from the slave, the channel remains idle because the slave never correctly received the initial packet. This is wasteful because the particular channel that would have been used in time slot 22, in fact, may have been a good channel. In FIG. 3b, the slave does correctly receive the master's packet 24, and even attempts to transmit back a responsive packet 28. However, the slave's response is not received by the master because the channel used in time slot 22 is bad.

In both cases, the master sends a packet but does not receive a response. The master has no way of knowing the source of the problem, that is, whether the initial packet 24 was not received by the slave (FIG. 3a) or whether the response from the slave did not make it back to the master (FIG. 3b). Either way, the transaction failed and is retried in its entirety. Thus, having a bad channel followed by a good channel or a good channel followed by bad channel results in wasted resources (i.e., the good channel).

The preferred embodiment of the invention attempts to ameliorate this problem by, in an optimal way, grouping together good channels that are separated from bad channels. This will be described in greater detail below. Referring again to FIG. 2, as noted above each wireless device 72 and 74 includes a radio 76 coupled to an antenna 78. Each device also includes an adaptive frequency hopping (“AFH”) logic unit 100. Broadly, the AFH logic 100 performs the function of grouping the channels as noted above.

Whereas various conventional hopping schemes hopped through channels regardless of whether the channels were good or bad, the adaptive frequency hopping scheme of the preferred embodiment takes into account whether a channel is good or bad when constructing the sequence of hop frequencies. The classification of a channel as good or bad preferably is determined in accordance with any suitable technique. For example, each of the potentially available channels can be monitored without an active transmission occurring on that channel to determine the background signal strength. Each channel can be judged to be good or bad based on a comparison of a channel metric to a predetermined value. For example, if the power level on a channel exceeds a predetermined threshold, then it can be determined that the channel is bad, otherwise the channel is judged to be good. Another technique is to measure the packet error rate for each channel (or hop frequency). A counter could be implemented for each channel. When a packet error occurs the counter is increased (could be by more than 1) and when a packet is received correctly, the counter is decremented. The minimum value of the counters should be zero. When a counter exceeds a threshold, the channel is declared bad. To increase the speed of the good/bad assessment, adjacent channels preferably are grouped together (e.g., fₖ₋₁, fₖ, fₖ₊₁). If fₖ is bad (good), then the counters associated for fₖ₋₁, fₖ, and fₖ₊₁ could be increased (decreased). The size of the grouping can be increased to speed up assessment even further. Minimum grouping should be limited to adjacent channels.

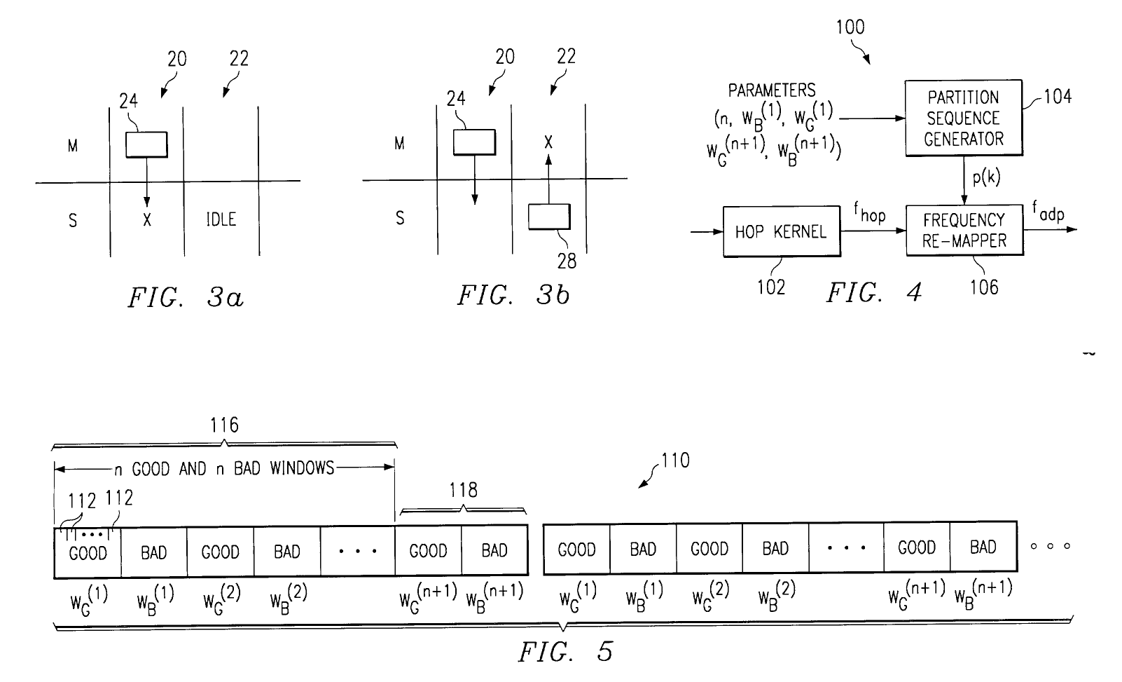

FIG. 4 provides greater detail regarding the construction of AFH 100. As shown in FIG. 4, AFH 100 preferably includes a hop kernel 102 and a partition sequence generator 104 both coupled to a frequency re-mapper 106. The hop kernel 102 preferably is any suitable type of “legacy” hop kernel which generates the sequence of hopping frequencies. The term “legacy” is intended to imply that the kernel 102 is a hop kernel that is well-known such as the hop kernel defined in the Bluetooth standard. The Bluetooth kernel is well known and has been implemented and tested. Because of the time and cost involved in developing and requalifying different hop kernels, it is preferred to use known, existing logic. As such, the adaptive frequency hop logic of the preferred embodiment uses a legacy hop kernel 102 as its starting point. With that stated, it should be understood that other hop kernels can be used as well.

The output from the hop kernel 102, designated as fₕₒₚ, represents a sequence of pseudo-random hop frequencies. That sequence may, and generally will, include both good and bad channels. The frequency re-mapper 106 uses the channel conditions and a partition sequence p(k) generated by the partition sequence generator 104 to re-map, if necessary, the fₕₒₚ sequence so that good and bad channels are grouped together as noted above to produce an adaptive frequency sequence, f_{adp}. The partition sequence p(k) indicates whether a frequency at the kth time slot in the adaptive frequency sequence, f_{adp}, to actually be used when hopping should be a good frequency or a bad frequency. Good frequencies are taken from the set of good channels denoted as S_{G} while bad frequencies are taken from a set of bad channels to be kept in the adapted hopping sequence denoted as S_{BK}. The set of bad channels, S_{BK}, preferably includes those channels that although bad, are the best of the bad channels according to whatever technique is used to differentiate good from bad channels.

In accordance with one embodiment of the invention, the good and bad channels are grouped together as shown in FIG. 5. The channels are arranged into successive “superframes” 110. Each superframe 110 preferably comprises one or more good “windows” (or groups) designated as W_{G}⁽¹⁾, W_{G}⁽²⁾, etc., and, if there are any bad channels to be included in the sequence, one or more bad windows designated as W_{B}⁽¹⁾, W_{B}⁽²⁾, etc. Each good and bad window comprises one or more time intervals 112 during which transmissions can occur. In accordance with the Bluetooth standard, the duration of each time interval is about 625 microseconds, although that is not significant. As shown, the superframe 110 preferably includes alternating good and bad windows. The superframe also is divided into two portions 116 and 118. A first portion 116 comprises n good windows and a like number of n bad windows. A second portion 118 may be included which comprises a single good window, denoted as W_{G}⁽ⁿ⁺¹⁾, and a single bad window denoted as W_{B}⁽ⁿ⁺¹⁾. Further, the lengths (preferably measured in terms of time) of all of the good windows in portion 116 are the same as are the lengths of all of the bad windows in portion 118. However, the lengths of the good windows in portion 116 may or may not be the same as the lengths of the bad windows. In fact, the good windows preferably are much longer than the bad windows. Window lengths are preferably even. Further still, two extra windows W_{G}⁽ⁿ⁺¹⁾ and W_{B}⁽ⁿ⁺¹⁾ in portion 118 have been added as shown to ensure compliance with the FCC regulations.

The structure defined in the superframes 110 of FIG. 5 provides an effective use of bad channels, when there are not enough good channels to comply with the applicable regulations. The preferred superframe structure provides an improved hopping structure which generally results in less interference because the good and bad channels are grouped together to reduce the frequency of occurrence of a good channel immediately following a bad channel, and vice versa.

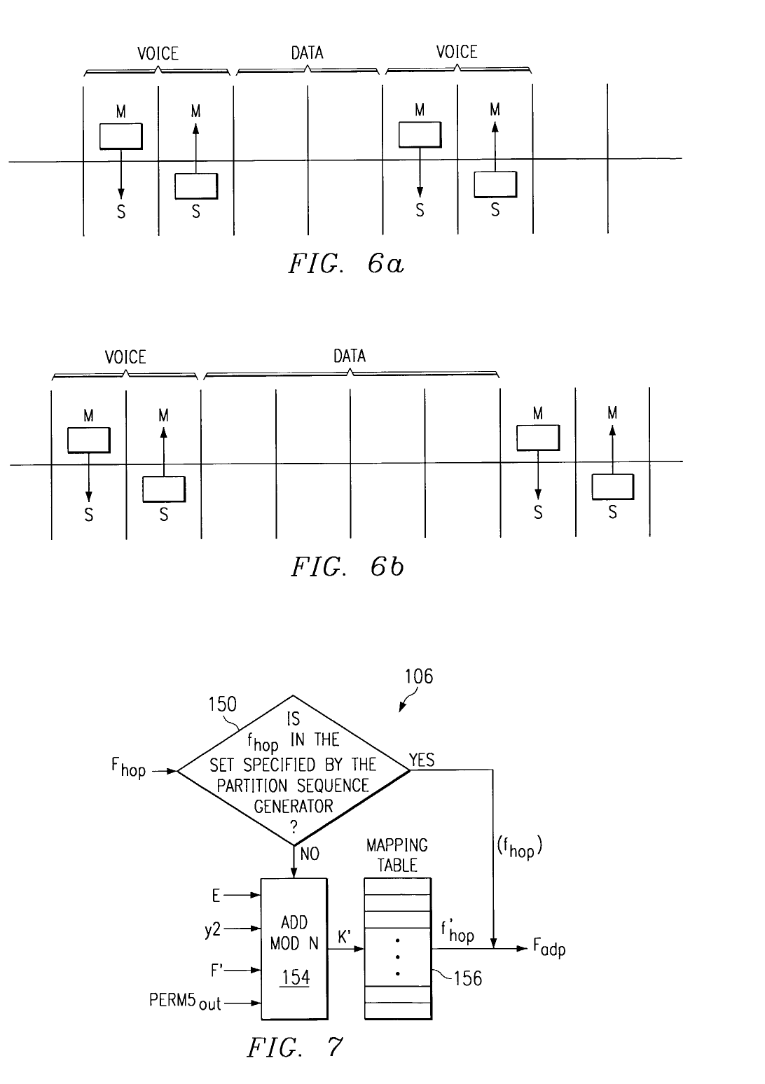

FIG. 5 introduces several parameters, namely, the length of the good windows in portion 116 (W_{G}⁽¹⁾), the length of the bad windows in portion 116 (W_{B}⁽¹⁾), the number of good channels in portion 116 (n), the length of the added good window (W_{G}⁽ⁿ⁺¹⁾) in portion 118 and the length of the added bad window (W_{B}⁽ⁿ⁺¹⁾ also in portion 118. The optimal values for these parameters depends on the type of wireless connection. For example, an asynchronous connection-less (“ACL”) provides packet-switched connection between the master and all active slaves. Packet retransmission are available to assure data integrity. ACL is typically used for transmitting data only, not voice. An HV2 connection is used for voice and data and has the structure shown in FIG. 6a. Two consecutive time slots are dedicated for the transmission of voice and are followed by two consecutive time slots which can be used for transmitting data, if there is any data to be transmitted. This pattern repeats with another consecutive pair of voice time slots. FIG. 6b shows an HV3 connection which defines four data time slots between pairs of voice time slots. An extended synchronous connection oriented (“eSCO”) connection is a circuit-switched connection. The eSCO packets include CRCs to add robustness. The eSCO mechanism also allows for retransmissions.

Table I below specifies how the parameters which define the superframes 110 are to be calculated. The column on the left pertains to ACL only connections (i.e., no voice) and the column on the right pertains to SCO+ACL connections. The values calculated in the manner shown in Table I reduce the inefficiencies caused by good and bad channels being immediately adjacent one another while also attempting to reduce the amount of dead time caused by bad channels and generally increasing throughput.

TABLE I
Superframe Parameter Definitions

| ACL Only Connection (no voice) | SCO + ACL Connection |
|---|---|
| ${W}_{B}^{( 1 )} = min \{ {PN}_{BK} , 2 ⌊ \frac{{T}_{d}}{2 {T}_{s}} ⌋ \}$ | ${W}_{G}^{( 1 )} = max \{ 2 , 2 ⌊ \frac{{PN}_{G}}{2 ( {N}_{G} + {N}_{BK}} ⌋ \}$ |
| $n = ⌊ \frac{{PN}_{BK}}{{W}_{B}^{( 1 )}} ⌋$ | ${W}_{B}^{( 1 )} = P - {W}_{G}^{( 1 )}$ |
| ${W}_{G}^{( 1 )} = 2 ⌊ \frac{{PN}_{G} - Δ}{2 n} ⌋$ | $n = min ( ⌊ \frac{{PN}_{G}}{{W}_{G}^{( 1 )}} ⌋ , ⌊ \frac{{PN}_{BK}}{{W}_{B}^{( 1 )}} ⌋ )$ |
| ${W}_{G}^{( n + 1 )} = {PN}_{G} - {nW}_{G}^{( 1 )}$ | ${W}_{G}^{( n + 1 )} = {PN}_{G} - {nW}_{G}^{( 1 )}$ |
| ${W}_{B}^{( n + 1 )} = {PN}_{BK} - {nW}_{B}^{( 1 )}$ | ${W}_{B}^{( n + 1 )} = {PN}_{BK} - {nW}_{B}^{( 1 )}$ |

The value N_{BK} refers to the number of bad channels that must be kept given the applicable regulatory requirement for the number of hopping channels and the available number of good channels. More specifically, N_{BK}=max(0, Nₘᵢₙ−N_{G}) where Nₘᵢₙ is the minimum number of hop channels and N_{G} is the number of good channels presently available. The value P preferably is defined as 2 for ACL only connections, 4 for HV2 connections, 6 for HV3 connections or the eSCO interval for eSCO connections. Further, T_{d} provides a time-out delay which is chosen so as to prevent a connection timeout which might otherwise occur if an excessive number of bad windows were included in such a way so as to result in no communications occurring for the timeout period of time. An exemplary value of is T_{d} should be less than 25 milliseconds. The value Tₛ is the slot time and is, for example, 625 microseconds. Also, the value Δ is 0 if W_{B}⁽¹⁾=2N_{BK}, and 1 otherwise.

The computation of W_{B}⁽¹⁾ is intended to define a maximum bad window size so as not to result in excessively long periods of silence. The computations of the parameters for the SCO+ACL connection advantageously protects the time periods which are dedicated to voice packet transmissions (see FIGS. 6a and 6b). it is desirable to ensure the error-free transmission of voice packets because, in accordance with the Bluetooth standard, voice packets cannot be retransmitted.

The equations provided in Table I are used when there is an insufficient number of good windows to comply with the regulatory requirements without the introduction of bad “filler” windows (i.e., N_{G}<Nₘᵢₙ). In the case in which there is a sufficient number of good windows (N_{G}>Nₘᵢₙ), the length of the bad window will be calculated as 0 and the number of good windows (n) will be calculated as 1. The result is only good channels in the hopping sequence. The partition sequence for this case preferably is all 1's, or other suitable value, to indicate that no re-mapping is to occur and that the hop sequence, fₕₒₚ, generated by the hop kernel is used as the adaptive hop sequence f_{adp}.

On the other hand, if there is an insufficient number of good channels to comply with the regulatory requirements imposed on the hop sequence, the parameters in Table I will result in an optimal set of parameters to reduce the deleterious effects of interference and noise.

Referring again to FIG. 2, the programmable logic 80 of the master 72 determines the good channels and the bad channels and performs the parameter calculations listed above in Table I. The master then transmits these values to the slaves 74. Once the parameters are received into each slave device's AFH 100, the slaves, and the master, can generate a partition sequence p(k) using the parameters to cause the legacy hop sequence, fₕₒₚ, to be re-ordered, if necessary, as described above to produce the adaptive sequence, f_{adp}, in accordance with the superframe construction. The partition sequence preferably comprises a binary sequence in which each value dictates whether an associated fₕₒₚ frequency is to be included in the adaptive sequence f_{adp} “as-is” or re-mapped on to a set of “opposite quality” channels (i.e., a good channel re-mapped to a bad channel, and vice versa). More specifically, the partition sequence preferably comprises a sequence of 1's and 0's in which 1's indicate that a good channel is needed and a 0 indicates that a bad channel is needed. This sequence of 1's and 0's indicating the sequence of good and channels causes the adaptive sequence to comport with the sequence of good and bad channels in the superframes discussed above.

The following exemplary pseudo-code produces appropriate values of p(k):

/* Loop through all of the good and bad windows */
For index = to n + 1,

/* Check to see if we are in the good or bad window */
If (index is not equal to n+1) then

W_{G} = W_{G}⁽¹⁾ and W_{B} = W_{B}⁽¹⁾

Else

W_{G = W}_{G}⁽ⁿ⁺¹⁾ and W_{B} = W_{B}⁽ⁿ⁺¹⁾

End

/* Loop through the good windows and generate partition sequence/*

For loop = 1 to W_{G}

p(k) = 1

End

/* Loop through the bad windows and generate partition sequence/*

For loop = 1 to W_{B}

p(k) = 0

End

End

Preferably, the same partition sequence is assigned to both the master and the slave. Accordingly, the complexity of the partition sequence can be further reduced by only updating the partition sequence on the master-to-slave time slot and using the same partition sequence value on the slave-to-master slot.

The basic principle behind the re-mapping function implemented by the frequency re-mapper 106 as explained above is to re-map the hop frequencies (fₕₒₚ) produced by the legacy hop kernel 102 on to the sequence of good and bad channels defined by the partitioned sequence p(k). If a particular legacy hop frequency is already in the sequence defined by the partition sequence (i.e., the legacy frequency is a good channel and a good channel is needed as dictated by p(k), and vice versa), then the corresponding frequency selected to be in the f_{adp} sequence by the frequency re-mapper 106 is the legacy hop frequency. If the legacy hop frequency is not in the required good or bad set defined by p(k), then the legacy frequency is re-mapped on to the opposite quality set of frequencies (i.e., good legacy frequency is mapped on to a bad frequency, and vice versa). Under the direction of the partition sequence generator, the re-mapper essentially converts a legacy hop sequence into a superframe sequence with the properties explained previously.

A preferred embodiment of frequency re-mapper 106 is shown in FIG. 7. As shown, frequency re-mapper includes decision logic 150 that determines whether the legacy-generated hop frequency, fₕₒₚ, is a member of the set specified by the partition sequence generator 104. If fₕₒₚ is in the set specified by the partition sequence generator, then that frequency, fₕₒₚ, is used as the frequency in the adaptive hopping sequence, f_{adp}.

If, however, fₕₒₚ is not in the set specified by the partition sequence generator, then a computation is made by logic 154. In accordance with the preferred embodiment, logic 154 adds the values E, Y2, F′ and PERM5ₒᵤₜ which, although not shown in FIG. 4, are values generated by the legacy hop kernel. These values are defined in the chapter 11 of the Bluetooth specification, pages 126-137, incorporated herein by reference. The value F′ is a modified version of the value F from the Bluetooth specification and is given by:

F′=16*CLK₂₇₋₇mod N

as one familiar with the Bluetooth specification would understand. The logic for calculating F′ may be included in re-mapper 106 or elsewhere such as in hop kernel 102. Logic 154 computes the value that is the sum of E, Y2, F′ and PERM5ₒᵤₜ mod N. The same structure shown in FIG. 7 is used for re-mapping onto the set of good channels and onto the set of bad channels. The only difference is N and the contents of mapping table 156. When re-mapping onto the set of good channels, N represents the number of good channels and the mapping table 156 contains only the good channels, where the even numbered channels are listed in ascending order followed by the odd channels also listed in ascending order. When re-mapping onto the set of bad channels, N represents the number of bad channels to be included in the hopping sequence and the mapping table 156 contains only the bad channels, where the even numbered channels are listed in ascending order followed by the odd channels also listed in ascending order.

The value K′ produced by logic 154 represents a new index value in the range of 0 to N−1 and is used as an index into the mapping table 156. Once a frequency is indexed, that frequency, f′ₖ, is used in the adaptive hopping sequence, f_{adp}. It should be noted that the logic shown in FIG. 7 has access to the set of good channels and bad channels and, as such, knows which channels are good and which are bad.

In summary, the preferred embodiment described above re-maps the frequency hop sequence of a hop kernel in accordance with an attempt to create groups of consecutive good and bad channels. This scheme reduces the potential for a good channel to be immediately followed by a bad channel and vice versa. If bad channels have to be added to a hop sequence to comply with applicable regulations, then the preferred embodiment described above provides an efficient and effective way to do so. The hopping mechanism disclosed herein is flexible enough to hop over only good channels when the number of good channels is sufficient to comply with the applicable regulations, but it can also intelligently structure the adaptive hopping sequence to minimize the effects of interference when bad channels must be used. Further, the preferred adaptive hopping mechanism generates the least amount of interference on other types of wireless networks (e.g., IEEE 802.11b) because the bad Bluetooth channels are grouped consecutively. By grouping bad channels, the Bluetooth packets will collide with fewer IEEE 802.11b packets. On the other hand, randomly appearing bad channels will result in Bluetooth packets colliding with more 802.11b packets. For an ACL only connection, the preferred hopping mechanism achieves the highest aggregate throughput. When multi-slot packets are used, packet-scheduling algorithms, which would optimize the length of the packets during the good windows, could be used to obtain even higher throughputs.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless device employing an adaptive frequency hopping scheme, comprising:
a hop kernel that produces a hop sequence of wireless frequency channels;
a frequency re-mapper coupled to said hop kernel; and
a partition sequence generator coupled to said frequency re-mapper;
wherein said partition sequence generator provides a partition sequence to said frequency re-mapper which is used by said frequency re-mapper to determine whether to re-map a channel in said hop sequence to a different channel.

2. The wireless device of claim 1 wherein the partition sequence causes said frequency re-mapper to create a first plurality of windows containing good channels and a second plurality of windows containing bad channels disposed between said first plurality of windows containing good channels.

3. The wireless device of claim 2 wherein said partition sequence further causes said frequency re-mapper to create a single window of good channels to follow said first and second plurality of windows of good and bad channels and a single window of bad channels following said single window of good channels.

4. The wireless device of claim 2 wherein each of said windows of good channels in said first plurality are of equal length.

5. The wireless device of claim 4 wherein each of said windows of bad channels in said second plurality are of equal length.

6. The wireless device of claim 5 wherein the windows of good channels in said first plurality are longer than the windows of bad channels in said second plurality.

7. The wireless device of claim 1 wherein said frequency re-mapper re-maps a bad channel from said hop kernel to a good channel.

8. The wireless device of claim 7 wherein said frequency re-mapper re-maps a good channel from said hop kernel to a bad channel.

9. The wireless device of claim 1 wherein said frequency re-mapper re-maps a good channel from said hop kernel to a bad channel.

10. The wireless device of claim 1 wherein said frequency re-mapper re-maps said channels based upon a connection type used by said wireless device, said connection type being a type selected from the group consisting of asynchronous connection-less (“ACL”), HV2, HV3 and extended synchronous connection oriented.

11. A wireless device employing an adaptive frequency hopping scheme, comprising:
a hop kernel that produces a hop sequence of wireless frequency channels; and
a frequency re-mapper coupled to said hop kernel and receiving said hop sequence, said frequency re-mapper determines whether to re-map a channel in said hop sequence to a different channel or accept said channel without re-mapping it to produce an adaptive frequency sequence.

12. The wireless device of claim 11 wherein the frequency re-mapper create a first plurality of windows containing good channels and a second plurality of windows containing bad channels disposed between said first plurality of windows containing good channels.

13. The wireless device of claim 12 wherein said frequency re-mapper creates a single window of good channels to follow said first and second plurality of windows of good and bad channels and a single window of bad channels following said single window of good channels.

14. The wireless device of claim 12 wherein each of said windows of good channels in said first plurality are of equal length.

15. The wireless device of claim 14 wherein each of said windows of bad channels in said second plurality are of equal length.

16. The wireless device of claim 15 wherein the windows of good channels in said first plurality are longer than the windows of bad channels in said second plurality.

17. The wireless device of claim 11 wherein said frequency re-mapper re-maps a bad channel from said hop kernel to a good channel.

18. The wireless device of claim 17 wherein said frequency re-mapper re-maps a good channel from said hop kernel to a bad channel.

19. The wireless device of claim 11 wherein said frequency re-mapper re-maps a good channel from said hop kernel to a bad channel.

20. The wireless device of claim 11 wherein said frequency re-mapper re-maps said channels based upon a connection type used by said wireless device, said connection type being a type selected from the group consisting of asynchronous connection-less (“ACL”), HV2, HV3 and extended synchronous connection oriented.

21. A wireless device which communicates with other wireless-capable devices using an adaptive frequency hopping scheme, comprising:
a hop kernel that produces a hop sequence of wireless frequency channels; and
a frequency re-mapper that receives said hop sequence and produces a plurality of groups of good channels and a second plurality of groups of bad channels, said second plurality disposed among said first plurality.

22. The wireless device of claim 21 wherein a group of bad channels follows each of said groups of good channels.

23. A method of wireless communications in a wireless network accessible to a plurality of channels, comprising:
(a) determining which of said channels are good and which are bad, said good channels being usable for communications and said bad channels being unusable for communications;
(b) grouping said good channels together;
(c) determining whether any bad channels are needed in said communications;
(d) if any bad channels are needed, then grouping said bad channels together; and
(e) sending and receiving communications by hopping among said good channels and, if they were needed, hopping among said bad channels.

24. The method of claim 23 wherein (b) includes creating a plurality of groups of good channels and (d) includes creating a plurality of groups of bad channels and said method further includes forming an adaptive sequence of channels comprising groups of bad channels disposed among groups of good channels.

25. The method of claim 24 wherein each group of good channels is followed by a group of bad channels.

26. A master wireless device comprising programmable logic and a wireless radio and an adaptive frequency hopping unit coupled to said programmable logic, wherein said programmable logic determines which of a plurality of accessible channels are good and which are bad and calculates values to be transmitted to a slave wireless device which the slave uses to form an adaptive hopping sequence of channels comprising windows of good channels and windows of bad channels disposed between said windows of good channels.

27. The master wireless device of claim 26 wherein the windows of good channels and the windows of bad channels have a predetermined length and said values determine the lengths of the windows of good and bad channels.

28. The master wireless device of claim 27 wherein said values also determine the total number of channels in said adaptive hopping sequence.

29. A partition sequence generator adapted to be coupled to a frequency re-mapper in a wireless device wherein said partition sequence generator generates a partition sequence to be provided to said frequency re-mapper to be used to re-map channels in a hop sequence to different channels.

30. The partition sequence generator of claim 29 wherein the partition sequence causes said frequency re-mapper to create a first plurality of windows containing good channels and a second plurality of windows containing bad channels disposed between said first plurality of windows containing good channels.

31. The partition sequence generator of claim 30 wherein said partition sequence further causes said frequency re-mapper to create a single window of good channels to follow said first and second plurality of windows of good and bad channels and a single window of bad channels following said single window of good channels.

32. A frequency re-mapper adapted to be coupled to a partition sequence generator in a wireless device and receive a partition sequence from said partition sequence generator to be used by said frequency re-mapper to re-map channels in a hop sequence to different channels.

33. A frequency re-mapper of claim 32 wherein the partition sequence causes said frequency re-mapper to create a first plurality of windows containing good channels and a second plurality of windows containing bad channels disposed between said first plurality of windows containing good channels.

34. A frequency re-mapper of claim 33 wherein said partition sequence further causes said frequency re-mapper to create a single window of good channels to follow said first and second plurality of windows of good and bad channels and a single window of bad channels following said single window of good channels.
